(19) United States
(12) Patent Application Publication
(10) Pub. No.: US 2017/0193487 A1
(43) Pub. Date: Jul. 6, 2017

(54) Method of Performing Micro-Transactions to Pay Off a Debt

(71) Applicant: Kiley Andrew Summers, Houston, TX (US)

(72) Inventor: Kiley Andrew Summers, Houston, TX (US)

(21) Appl. No.: 15/399,734

(22) Filed: Jan. 5, 2017

Related U.S. Application Data
(60) Provisional application No. 62/274,812, filed on Jan. 5, 2016.

(51) Int. Cl. G06Q 20/22; G06Q 40/00

(52) U.S. Cl. CPC G06Q 20/29; G06Q 40/12

(57) ABSTRACT

A method of performing micro-transactions to pay-off a debt that is used to automatically withdraw funds from an external withdrawal account and deposit said funds into an external deposit account at the end of a given financial transaction. The method is used to track the financial transactions made by multiple users via multiple financial accounts. The method is designed to determine the specific user responsible for making a given financial transaction. Additionally, the method determines the external withdrawal account used by the user to complete the financial transaction. Once the user and withdrawal account are determined, the method executes a savings transaction process to perform a micro-transaction and deposit a supplementary savings amount into the appropriate external deposit account.

The current application claims a priority to the U.S. Provisional Patent application Ser. No. 62/274,812 filed on Jan. 5, 2016.

### FIELD OF THE INVENTION

The present invention relates generally to an application for making automated micropayments toward a debt. More specifically, the present invention relates to a system that executes micro-transactions to deposit sums of money into a user-defined financial account, thereby paying off a debt or paying into a savings account.

### BACKGROUND OF THE INVENTION

To help individuals with debt management, there are a number of applications which help to automate debt payments based on user transactions. The present invention is one such application, with a unique setup and process for managing automated micropayments for debts.

The present invention (“Debt Controller”) serves as a customized automated Add-On program which can be implemented as an application for smart devices, interface tool via the World Wide Web, and/or a financial institution program offering. The present invention assists users in making small iterative debt payments (such as from debt agencies, department store loans, medical bills, and so on). These payments are automatically made in conjunction with spending from a bank account. Just as the slogan “. . . I wish I had a nickel for every time I said that . . . ” the present invention serves that philosophical statement by debt repayment through purchasing and adding a nickel or any specified amount every time a transaction is made.

The present invention allows users to define a finite amount to be added onto each financial transaction made using their banking information, credit card purchases, or through any electronic payment. Users can select the specific debt (e.g. student loan or monthly bill) the finite Add-On amount will be routed to as a simultaneous or real-time transaction which is initiated with a purchase or debit transaction by the user or user's account. In addition, the user can regulate the Targeted Amount to add per banking cycle, set the Number of Transactions per banking cycle, apply Add-On program only when spending at Selected Merchants, define a Limited Pay-off amount towards a specific debt or bill based on the owed amount, define a Percentage of a Transaction to be the Add-On amount applied towards a debt, define Percentage of the Add-On amount to be applied to multiple debts, and/or leverage the Snowball Affect which allows users to list their selected debts and pay them off in a defined automated order. The present invention can help to pay loans (e.g. student loans, credit cards, car loans) in addition to bills. Examples of bills that can be paid off through the present invention include phone bills, water bills, electric bills, and more.

To use the present invention, a potential user downloads the application to their respective smart device or visits the World Wide Web program via a computer. From there, the potential user would sign up, log in, and fill out the required information for their profile using their personal information; to include their bank account information. Once the bank account information is added, the user can upload electronic bills and/or loan information for the specific debt(s) the user want to paydown and/or pay-off. Once the user has selected the targeted debt, the user will define the finite amount to be added to purchases or debit transactions. The finite amount is routed to selected bill(s) or loan(s) at the same time a purchase or debit transaction is made, as long as the user is spending from the bank account associated with the user's “Debt Controller” profile.

Overall, the present invention is aimed to focus on reducing the user's debt, however, the architect of the program supports saving, investing, donating, rewarding of loyalty programs, gifting peer to peer, etc. The design of the program provides a unique dimension in the financial industry.

### BRIEF DESCRIPTION OF THE DRAWINGS

FIG. 1 is a block diagram illustrating the system overview of the present invention.

FIG. 2 is a flowchart describing the overall process followed by the method of the present invention.

FIG. 3 is a flowchart describing a process of adding an external withdrawal account or an external deposit account.

FIG. 4 is a flowchart describing a process for designating a pre-defined supplementary transfer amount to be transferred during the savings transaction process.

FIG. 5 is a flowchart describing a process for designating a user-defined supplementary transfer amount to be transferred during the savings transaction process.

FIG. 6 is a flowchart describing a process for designating a transfer ratio for the supplementary transfer amount to be transferred during the savings transaction process.

FIG. 7 is a flowchart describing a process for designating a desired deposit account to receive the supplementary transfer amount during the savings transaction process.

FIG. 8 is a flowchart describing a process for designating an external deposit account that will be the recipient of funds transferred out of an external withdrawal account.

FIG. 9 is a flowchart describing a process for sending a transfer-funds request to the origin withdrawal account after a single transaction.

FIG. 10 is a flowchart describing a process for sending a lump sum transfer-funds request to the origin withdrawal account after a prespecified period of time.

FIG. 11 is a flowchart describing a process for sending a lump sum transfer-funds request to the origin withdrawal account after the value of the lump sum reaches a prespecified amount.

### DETAIL DESCRIPTIONS OF THE INVENTION

All illustrations of the drawings are for the purpose of describing selected versions of the present invention and are not intended to limit the scope of the present invention.

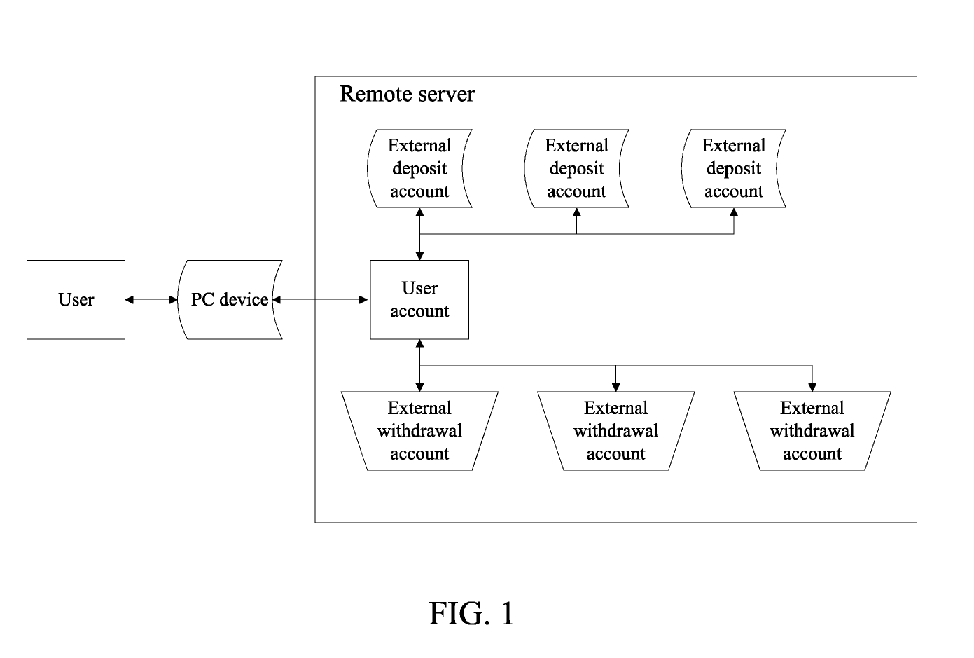

As can be seen in FIG. 1 through FIG. 11, the present invention is a method of performing micro-transactions to pay off a debt. The present invention is preferably designed as a mobile application or web-based system. The present invention enables a user to manage automated micro-transactions that are used to pay off a debt or to transfer funds between the user's registered financial accounts. The term micro-transaction is used herein to refer to the process of withdrawing a sum of money from one financial account and depositing said sum of money into a desired account. The present invention performs the automated micro-transaction whenever the user makes a purchase or payment using one of the user's registered financial accounts. Additionally, the present invention enables the user to specify how the funds from the micro-transactions are disbursed. For example, the user is able to specify how much will be deducted during a micro-transaction, the registered financial account to which the funds will be transferred, and how frequently the funds will be transferred.

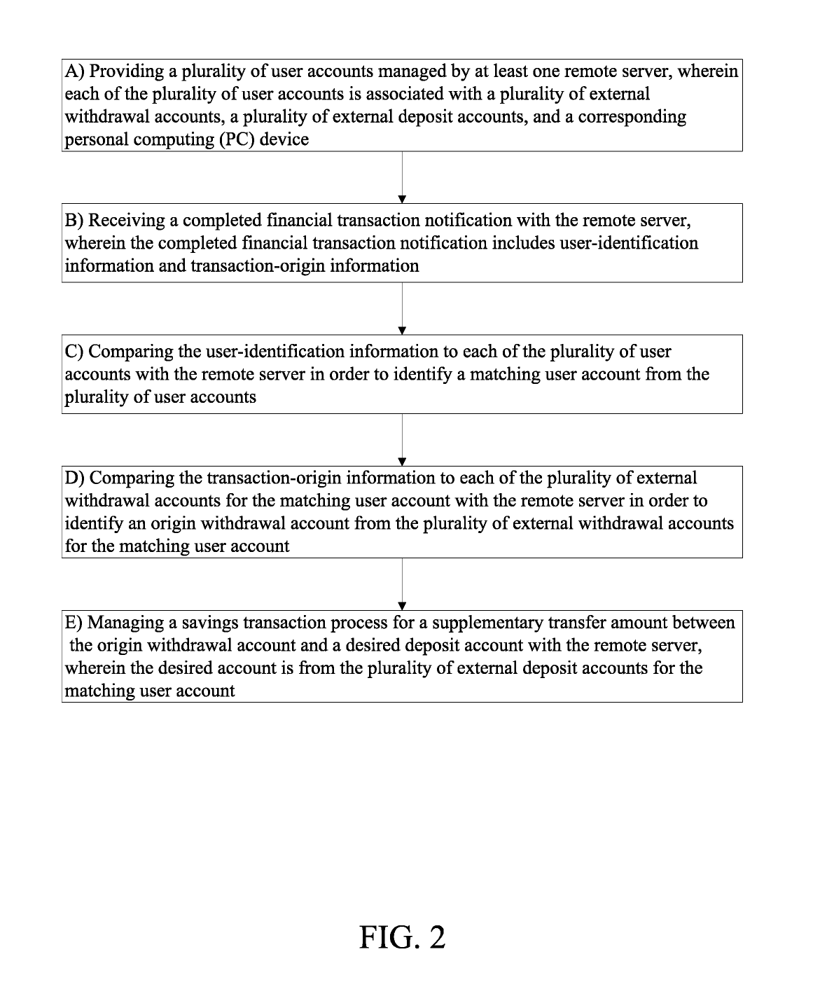

As can be seen in FIG. 1 and FIG. 2, the system used to execute the method of the present invention allows the present invention to manage the financial activity for a large number of users. Consequently, the present invention individually identifies each user with a plurality of user accounts. A user account allows the present invention to individually identify and interact with each user. The present invention includes at least one remote server to manage the plurality of user accounts, each of which is associated with a plurality of external withdrawal accounts, a plurality of external deposit accounts, and a corresponding personal computing (PC) device (Step A). The corresponding PC device is used to receive input from a user and is used to relay information between the remote server and the user. The corresponding PC device can be, but is not limited to, a smart-phone, a laptop, a desktop, or a tablet PC. The remote server is used to communicate with the banks and financial institutions tied to each of the plurality of external withdrawal accounts and to each of the plurality of deposit accounts. Furthermore, the remote server is used to execute a number of internal processes for the present invention and is used to store personal preferences for each of the plurality of user accounts. Each withdrawal account from the plurality of external withdrawal accounts is a financial account that is associated with a single user. The user authorizes the present invention to interact with the external financial institution responsible for managing the external withdrawal account. For example, the user gives the present invention to view the transactions of, and withdraw funds from, a banking or credit account. Similarly, each deposit account from the plurality of external deposit accounts is a financial account that is associated with a single user. The user authorizes the present invention to interact with the external financial institution responsible for managing the external deposit account. The external deposit account could be something similar to a debt, a credit card, or a savings account.

As can be seen in FIG. 2, the overall process followed by the method of the present invention allows a user to manage financial responsibilities such as paying off a debt or paying into a savings account. The overall process begins by receiving a completed financial transaction notification with the remote server (Step B). The completed financial transaction notification is a message that is transmitted to the present invention by an external financial institution that is tied to one of the external withdrawal accounts. This notification alerts the present invention that a user has made a financial transaction. Additionally, the completed financial transaction notification includes user-identification information and transaction-origin information. The included user-identification information enables the present invention to determine the user account that completed the financial transaction. Similarly, the transaction-origin information enables the present invention to determine the withdrawal account used to complete the financial transaction. More specifically, the transaction-origin information is used to identify the external financial institution that has completed the financial transaction e.g. the completed financial transaction was done by Visa, Mastercard, etc.

As can be seen in FIG. 2, the overall process of the present invention continues by comparing the user-identification information to each of the plurality of user accounts with the remote server in order to identify a matching user account from the plurality of user accounts (Step C). This step is used to determine the appropriate user account for which the completed financial transaction notification was received. The overall process of the present invention continues by comparing the transaction-origin information to each of the plurality of external withdrawal accounts for the matching user account with the remote server in order to identify an origin withdrawal account from the plurality of external withdrawal accounts for the matching user account (Step D). The origin withdrawal account is one of the plurality of external withdrawal accounts that is tied to the user account. Additionally, the origin withdrawal account indicates the external financial institution from which funds are transferred when the present invention executes the subsequent micro-transaction in response to the completed financial transaction.

As can be seen in FIG. 2, the overall process of the present invention concludes by managing a savings transaction process for a supplementary transfer amount between the origin withdrawal account and a desired deposit account with the remote server (Step E). The desired deposit account is one of the plurality of external deposit accounts that have been specified by the user to function as the recipient of the funds from the savings transaction. The supplementary transfer amount is a pre-defined sum of money that is transferred from one external withdrawal account into an external deposit account during the savings transaction process. The savings transaction process is a sub-process used to execute a micro-transaction where the supplementary transfer amount is withdrawn from the origin withdrawal account and deposited into the desired deposit account.

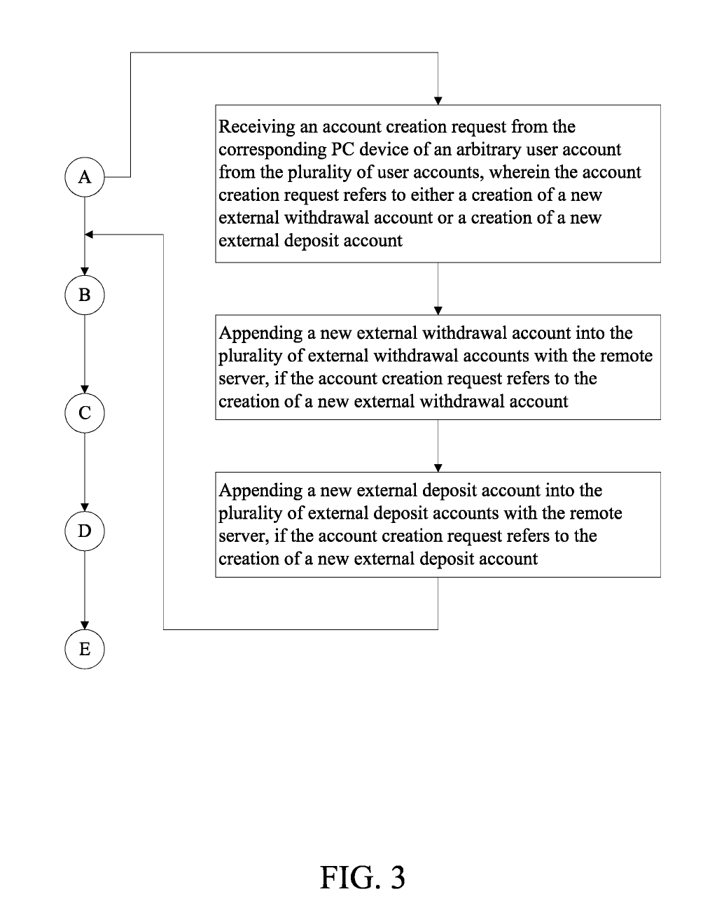

As can be seen in FIG. 3, a sub-process of the method of the present invention enables a user account to add at least one external withdrawal account to the plurality of external withdrawal accounts. Additionally, this sub-process of the present invention enables the user account to add at least one external deposit account to the plurality of external deposit accounts. The sub-process takes place during Step A and begins by receiving an account creation request from the corresponding PC device of an arbitrary user account from the plurality of user accounts. The account creation request is a user generated command that directs the present invention to create either an external withdrawal account or an external deposit account. The account creation request contains the information required to specify the external financial institution that is tied to the created account. Additionally, the user authorizes the present invention to interact with the external financial institution on the user's behalf through the account creation request. The sub-process concludes by appending a new external withdrawal account into the plurality of external withdrawal accounts with the remote server, if the account creation request refers to the creation of a new external withdrawal account. This step of the sub-process is a conditional statement that is used to determine if the user wants to create a new external withdrawal account or a new external deposit account. To that end, the sub-process concludes by appending a new external deposit account into the plurality of external deposit accounts with the remote server, if the account creation request refers to the creation of a new external deposit account.

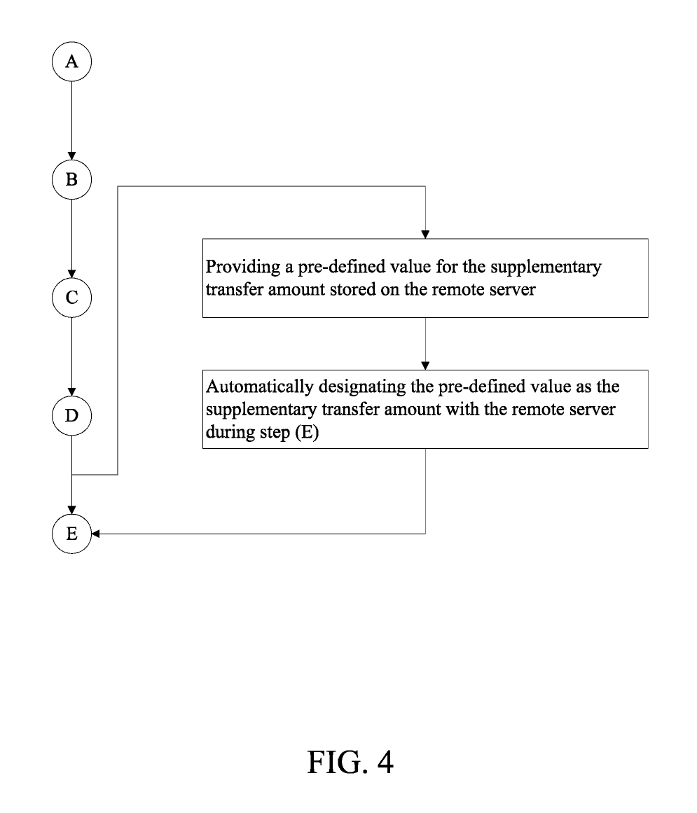

As can be seen in FIG. 4, a sub-process of the method of the present invention is used to pre-define the amount of money that is transferred from a withdrawal account to a deposit account during the savings transaction process. The sub-process begins by providing a pre-defined value for the supplementary transfer amount stored on the remote server. The pre-defined value is a default sum of money that the present invention withdraws from an external withdrawal account during the savings transaction process. The sub-process concludes by automatically designating the pre-defined value as the supplementary transfer amount with the remote server during Step E. The present invention allows the user to automatically apply a pre-defined value to be withdrawn during the savings transaction process. This enables the user to direct the present invention to withdraw a recommended value from an external withdrawal account as a micro-transaction. Because of this functionality, the user can receive guidance when moving toward achieving financial goals.

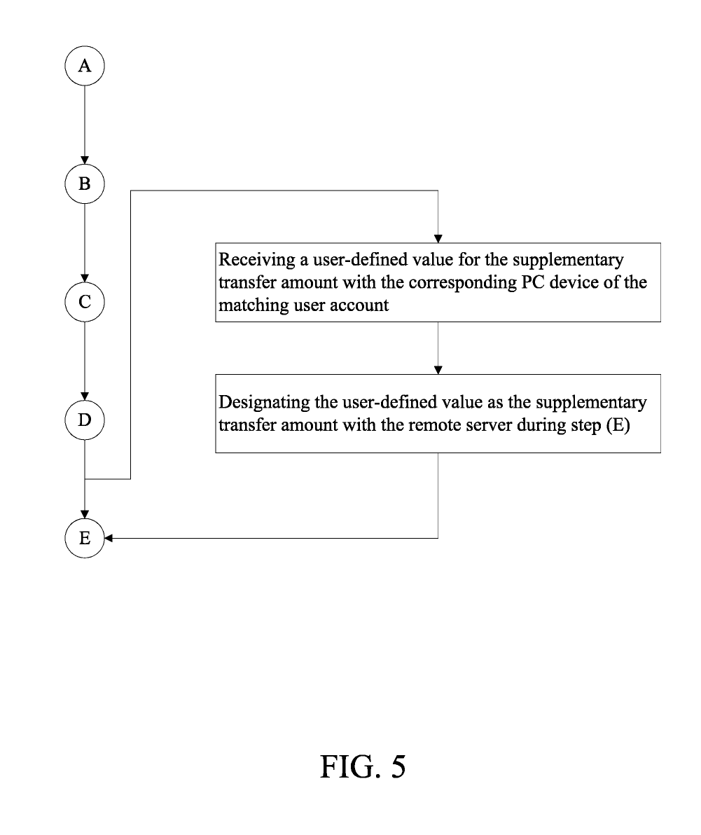

As can be seen in FIG. 5, a sub-process of the method of the present invention allows the user to define the amount of money that is transferred from a withdrawal account to a deposit account during the savings transaction process. The sub-process begins by receiving a user-defined value for the supplementary transfer amount with the corresponding PC device of the matching user account. The user-defined value is a sum of money that the present invention withdraws from an external withdrawal account during the savings transaction process. The sub-process concludes by designating the user-defined value as the supplementary transfer amount with the remote server during Step E. The present invention allows the user to specify the user-defined value to be withdrawn during the savings transaction process. This enables the user to direct the present invention to withdraw an explicitly selected value from an external withdrawal account as a micro-transaction. Because of this functionality, the user is empowered to make financial decisions when moving toward achieving financial goals.

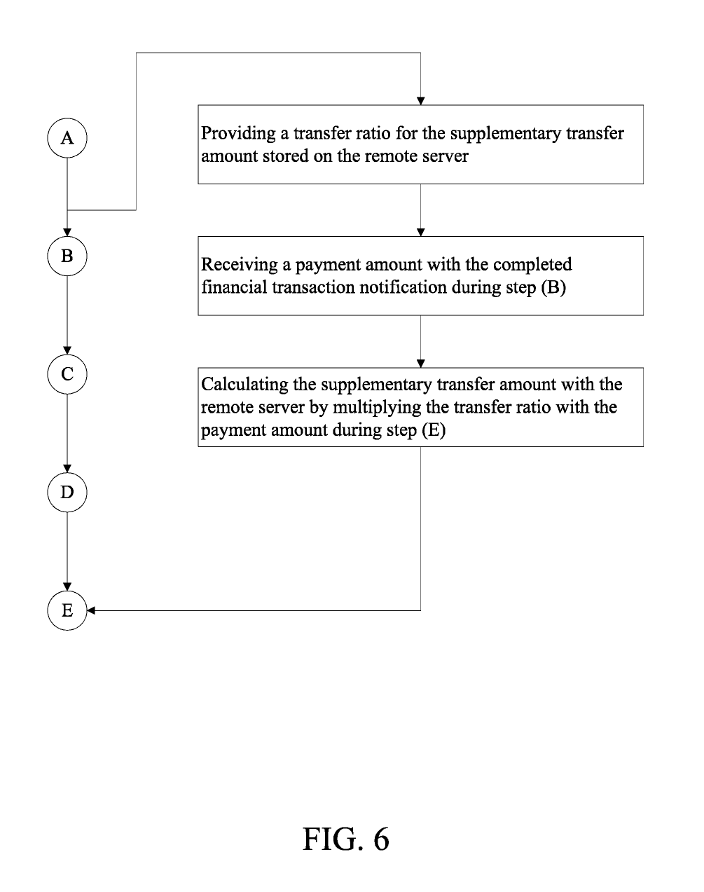

As can be seen in FIG. 6, a sub-process of the method of the present invention is used to dynamically modify the amount of money that is transferred from a withdrawal account to a deposit account during the savings transaction process. In this sub-process, the present invention provides a transfer ratio for the supplementary transfer amount stored on the remote server. The transfer ratio is used to determine what percentage of the money spent during a financial transaction should be transferred out of an external withdrawal account and into an external deposit account. The sub-process begins by receiving a payment amount with the completed financial transaction notification during Step B. The payment amount is a data point contained within the completed financial transaction notification that specifies how much money was spent during the preceding financial transaction. The sub-process concludes by calculating the supplementary transfer amount with the remote server by multiplying the transfer ratio with the payment amount during Step E. Consequently, the present invention allows the user to apply a dynamically modified value to be withdrawn during the savings transaction process. This enables the present invention to withdraw more money from an external withdrawal account as a micro-transaction if the user spends more money during a financial transaction.

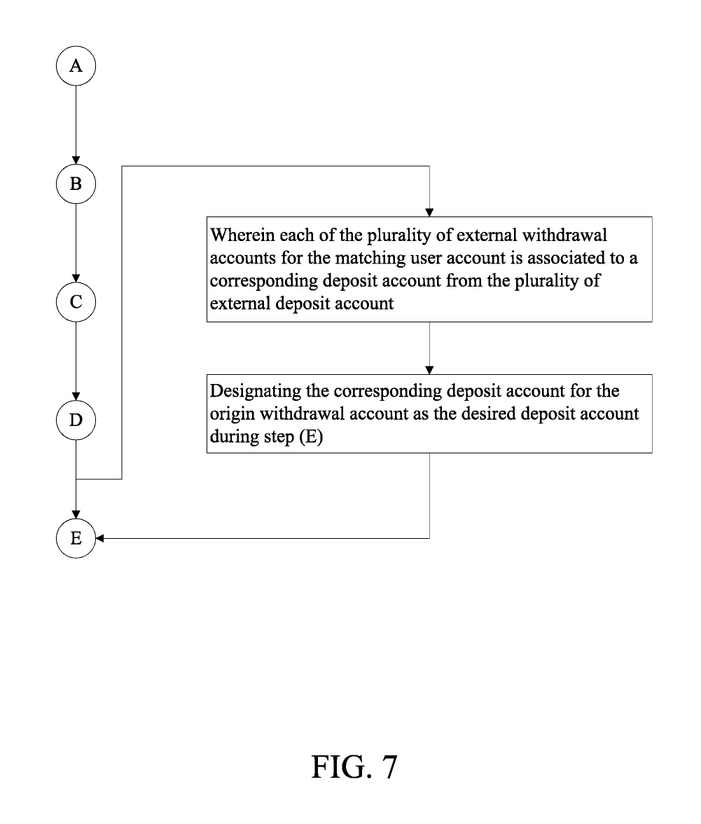

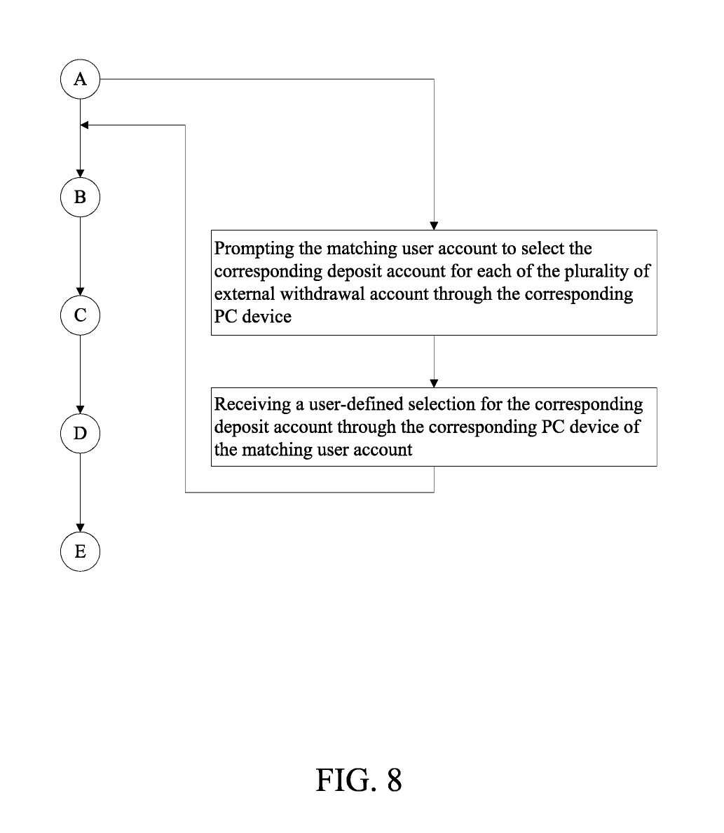

As can be seen in FIG. 7 and FIG. 8, a sub-process of the present invention is used to define the desired deposit account that will be the recipient of the supplementary transfer amount whenever a specific origin withdrawal account is used for a savings transaction process. To that end, each of the plurality of external withdrawal accounts for the matching user account is associated to a corresponding deposit account from the plurality of external deposit account. This sub-process is used for designating the corresponding deposit account for the origin withdrawal account as the desired deposit account during Step E with the remote server. To accomplish this, a secondary process begins by prompting the matching user account to select the corresponding deposit account for each of the plurality of external withdrawal account through the corresponding PC device. This secondary process allows the user to specify which external deposit account will be used as the desired deposit account for a given origin withdrawal account. The secondary process concludes by receiving a user-defined selection for the corresponding deposit account through the corresponding PC device of the matching user account. The present invention uses the received user-defined selections to dictate how funds are transferred from the plurality of external withdrawal accounts to the plurality of external deposit accounts. For example, the user is able to specify that all purchases made with a specific visa card have a supplementary transfer amount that is transferred to a student loan account. In this way, the user is able to pay off the student loan without taking any additional steps.

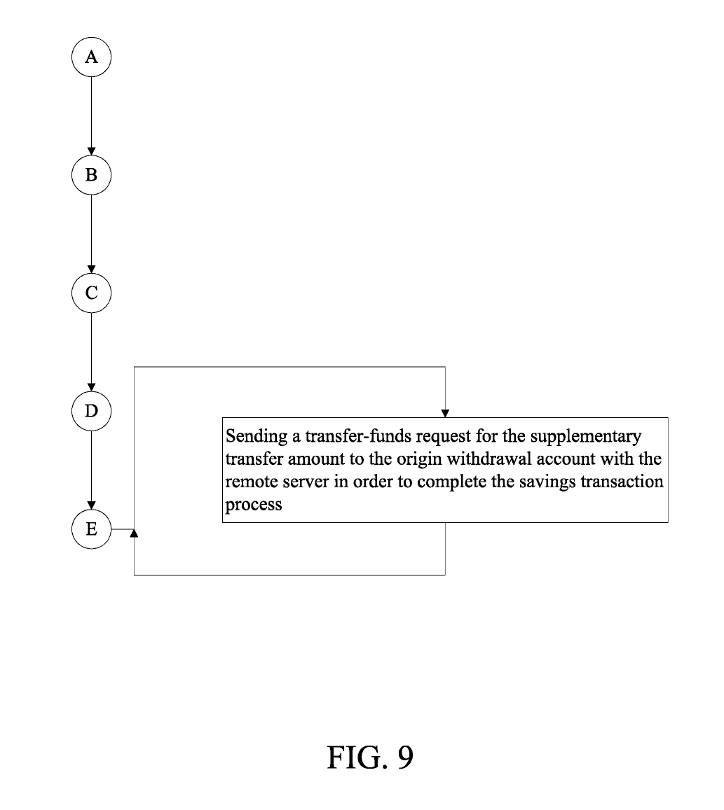

As can be seen in FIG. 9, a sub-process of the present invention completes the savings transaction process by immediately transferring the supplementary transfer amount from an origin withdrawal account to a desired deposit account. This sub-process concludes by sending a transfer-funds request for the supplementary transfer amount to the origin withdrawal account with the remote server in order to complete the savings transaction process.

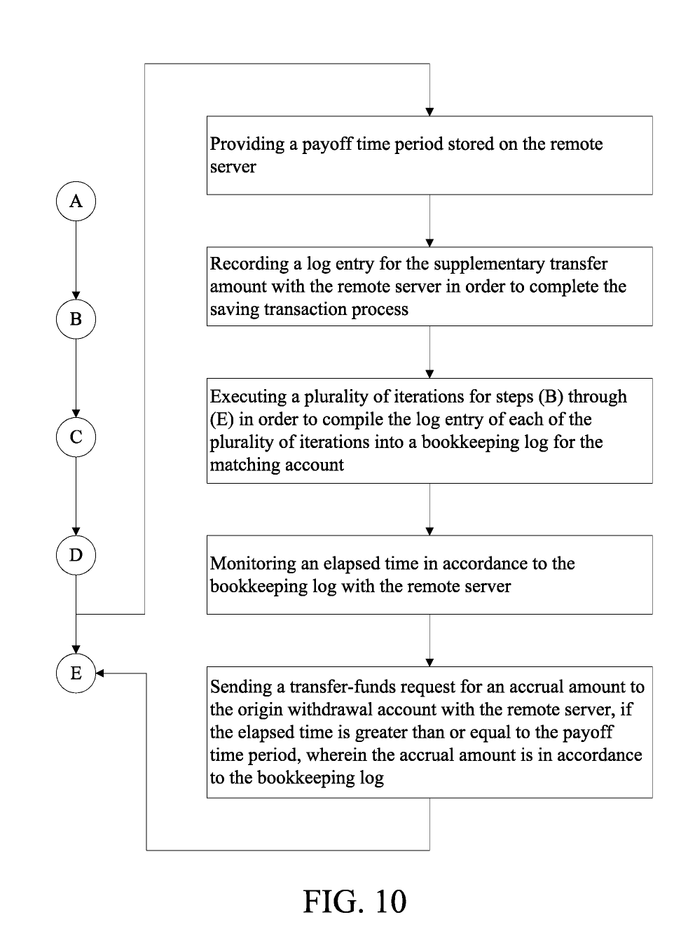

As can be seen in FIG. 10, a separate sub-process that is an alternative to the sub-process disclosed in the previous paragraph is used to transfer all of the supplementary transfer amounts accrued over a given period of time as a single lump sum. In this sub-process, a pay-off time period is stored in the remote server. The user is able to specify the pay-off time period. Conversely, the pay-off time period can be a pre-defined value. In either case, the pay-off time period is the length of time that the present invention accrues a batch of supplementary transfer amounts before transferring the entire batch as a lump sum. The sub-process begins by recording a log entry for the supplementary transfer amount with the remote server in order to complete the saving transaction process. The log entry is a note of the supplementary transfer amount that is transferred from the origin withdrawal account to the desired deposit account after the pay-off period has expired. The sub-process continues by executing a plurality of iterations for Steps B through Step E in order to compile the log entry of each of the plurality of iterations into a bookkeeping log for the matching account. The bookkeeping log is a record of the supplementary transfer amounts that should be withdrawn from an origin withdrawal account and deposited into a desired deposit account. As the user performs multiple transactions, the present invention stores the corresponding supplementary transfer amounts in the bookkeeping log. The sub-process continues by monitoring an elapsed time in accordance to the bookkeeping log with the remote server. This enables the present invention to determine how much time has passed since the last pay-off time period expired. Finally, the sub-process concludes by sending a transfer-funds request for an accrual amount to the origin withdrawal account with the remote server, if the elapsed time is greater than or equal to the pay-off time period, wherein the accrual amount is in accordance to the bookkeeping log. The accrual amount is the total amount that should be transferred from an origin withdrawal account and deposited into a desired deposit account as denoted by the bookkeeping log.

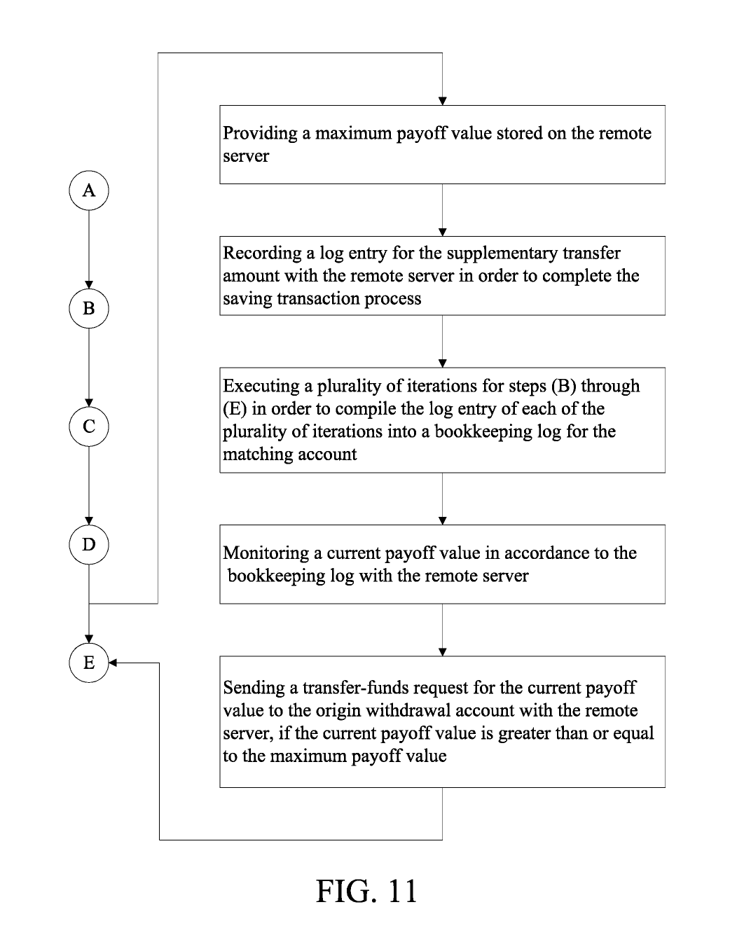

As can be seen in FIG. 11, a sub-process that is an alternative to the sub-process disclosed in the previous two paragraphs is used to aggregate all of the supplementary transfer amounts until a pre-defined value is reached and then transfer the aggregated supplementary transfer amounts as a single lump sum. In this sub-process, a maximum pay-off value is stored in the remote server. The user is able to specify the maximum pay-off value. Conversely, the maximum pay-off value can be a pre-defined value. In either case, the maximum pay-off value is the amount at which the present invention transfers a batch of supplementary transfer amounts as a lump sum. The sub-process begins by recording a log entry for the supplementary transfer amount with the remote server in order to complete the saving transaction process. The log entry is a note of the supplementary transfer amount that is transferred from the origin withdrawal account to the desired deposit account after the maximum pay-off value is reached. The sub-process continues by executing a plurality of iterations for Steps B through Step E in order to compile the log entry of each of the plurality of iterations into a bookkeeping log for the matching account. As the user performs multiple transactions, the present invention stores the corresponding supplementary transfer amounts in the bookkeeping log. The sub-process continues by monitoring a current pay-off value in accordance to the bookkeeping log with the remote server. This enables the present invention to determine the value of the aggregated supplementary transfer amounts. Finally, the sub-process concludes by sending a transfer-funds request for the current pay-off value to the origin withdrawal account with the remote server, if the current pay-off value is greater than or equal to the maximum pay-off value. The current pay-off value is the total amount that should be transferred from an origin withdrawal account and deposited into a desired deposit account as denoted by the bookkeeping log.

Although the invention has been explained in relation to its preferred embodiment, it is to be understood that many other possible modifications and variations can be made without departing from the spirit and scope of the invention as hereinafter claimed.

What is claimed is:

1. A method of performing micro-transactions to pay off a debt, the method comprises the steps of:
(A) providing a plurality of user accounts managed by at least one remote server, wherein each of the plurality of user accounts is associated with a plurality of external withdrawal accounts, a plurality of external deposit accounts, and a corresponding personal computing (PC) device;
(B) receiving a completed financial transaction notification with the remote server, wherein the completed financial transaction notification includes user-identification information and transaction-origin information;
(C) comparing the user-identification information to each of the plurality of user accounts with the remote server in order to identify a matching user account from the plurality of user accounts;
(D) comparing the transaction-origin information to each of the plurality of external withdrawal accounts for the matching user account with the remote server in order to identify an origin withdrawal account from the plurality of external withdrawal accounts for the matching user account; and
(E) managing a savings transaction process for a supplementary transfer amount between the origin withdrawal account and a desired deposit account with the remote server, wherein the desired account is from the plurality of external deposit accounts for the matching user account.

2. The method of performing micro-transactions to pay off a debt, the method as claimed in claim 1 comprises the steps of:
receiving an account creation request from the corresponding PC device of an arbitrary user account from the plurality of user accounts, wherein the account creation request refers to either a creation of a new external withdrawal account or a creation of a new external deposit account;
appending a new external withdrawal account into the plurality of external withdrawal accounts with the remote server, if the account creation request refers to the creation of a new external withdrawal account, and
appending a new external deposit account into the plurality of external deposit accounts with the remote server, if the account creation request refers to the creation of a new external deposit account.

3. The method of performing micro-transactions to pay off a debt, the method as claimed in claim 1 comprises the steps of:
providing a pre-defined value for the supplementary transfer amount stored on the remote server, and
automatically designating the pre-defined value as the supplementary transfer amount with the remote server during step (E).

4. The method of performing micro-transactions to pay off a debt, the method as claimed in claim 1 comprises the steps of:
receiving a user-defined value for the supplementary transfer amount with the corresponding PC device of the matching user account, and
designating the user-defined value as the supplementary transfer amount with the remote server during step (E).

5. The method of performing micro-transactions to pay off a debt, the method as claimed in claim 1 comprises the steps of:
providing a transfer ratio for the supplementary transfer amount stored on the remote server;
receiving a payment amount with the completed financial transaction notification during step (B), and
calculating the supplementary transfer amount with the remote server by multiplying the transfer ratio with the payment amount during step (E).

6. The method of performing micro-transactions to pay off a debt, the method as claimed in claim 1 comprises the steps of:
wherein each of the plurality of external withdrawal accounts for the matching user account is associated to a corresponding deposit account from the plurality of external deposit account, and
designating the corresponding deposit account for the origin withdrawal account as the desired deposit account during step (E) with the remote server.

7. The method of performing micro-transactions to pay off a debt, the method as claimed in claim 6 comprises the steps of:
prompting the matching user account to select the corresponding deposit account for each of the plurality of external withdrawal account through the corresponding PC device, and
receiving a user-defined selection for the corresponding deposit account through the corresponding PC device of the matching user account.

8. The method of performing micro-transactions to pay off a debt, the method as claimed in claim 1 comprises the steps of:
sending a transfer-funds request for the supplementary transfer amount to the origin withdrawal account with the remote server in order to complete the savings transaction process.

9. The method of performing micro-transactions to pay off a debt, the method as claimed in claim 1 comprises the steps of:
providing a pay-off time period stored on the remote server;
recording a log entry for the supplementary transfer amount with the remote server in order to complete the saving transaction process;
executing a plurality of iterations for steps (B) through (E) in order to compile the log entry of each of the plurality of iterations into a bookkeeping log for the matching account;
monitoring an elapsed time in accordance to the bookkeeping log with the remote server, and
sending a transfer-funds request for an accrual amount to the origin withdrawal account with the remote server, if the elapsed time is greater than or equal to the pay-off time period, wherein the accrual amount is in accordance to the bookkeeping log.

10. The method of performing micro-transactions to pay off a debt, the method as claimed in claim 1 comprises the steps of:
providing a maximum pay-off value stored on the remote server;
recording a log entry for the supplementary transfer amount with the remote server in order to complete the saving transaction process;
executing a plurality of iterations for steps (B) through (E) in order to compile the log entry of each of the plurality of iterations into a bookkeeping log for the matching account;
monitoring a current pay-off value in accordance to the bookkeeping log with the remote server, and
sending a transfer-funds request for the current pay-off value to the origin withdrawal account with the remote server, if the current pay-off value is greater than or equal to the maximum pay-off value.
